(19) United States
(12) Patent Application Publication
(10) Pub. No.: US 2013/0194099 A1
(43) Pub. Date: Aug. 1, 2013

(54) DRIVING ASSISTANCE APPARATUS

(71) Applicant: DENSO CORPORATION, Kariya-city (JP)

(72) Inventor: Takashi NAGATA, Nagoya-city (JP)

(73) Assignee: DENSO CORPORATION, Kariya-city (JP)

(21) Appl. No.: 13/742,402

(22) Filed: Jan. 16, 2013

(30) Foreign Application Priority Data
Jan. 26, 2012 (JP) 2012-14102

(51) Int. Cl. G08B 21/06

(52) U.S. Cl. CPC G08B 21/06
USPC 340/575

(57) ABSTRACT

A driving assistance apparatus detects drowsiness of a driver of a vehicle while having a drowsy driving preventing function for awaking the driver having feeling of drowsiness. When erroneous detection of drowsy driving occurs frequently, the driver may deactivate the drowsy driving preventing function into an off state. The driving assistance apparatus determines a stress of the driver due to driving based on travel states of the vehicle obtained from a navigation apparatus such as traffic around the vehicle, a width and shape of a road traveled, installation states of traffic signals, and a velocity and steering angle of the vehicle. When the stress due to driving changes from a high status to a low status, the driver is regarded as being in a state of tending to be drowsy. The drowsy driving preventing function is thereby activated or turned on into an on state compulsorily.

### CROSS REFERENCE TO RELATED APPLICATION

The present application is based on Japanese Patent Application No. 201244102 filed on Jan. 26, 2012, the disclosure of which is incorporated herein by reference.

### TECHNICAL FIELD

The present disclosure relates to a driving assistance apparatus for preventing drowsy driving by a driver.

### BACKGROUND ART

[Patent Literature 1]: JP 2010-67137 A (US 2011/0205350 A)

For instance, Patent Literature 1 proposes a drowsy driving preventing function, which detects drowsy driving based on facial images and driving manipulations of drivers and warn the drivers so as to awake the drivers when detecting the drowsy driving.

Whereas such a drowsy driving preventing function may prevent a drowsy driving, an erroneous detection of drowsy driving may occur. When the erroneous detection of drowsy driving occurs frequently, the driver, who is awake, is repeatedly warned unnecessarily. This provides a sense of discomfort to the driver, who may thereby deactivate the drowsy driving preventing function intentionally.

### SUMMARY

It is an object of he present disclosure to provide a driving assistance apparatus to achieve drowsy driving prevention more certainly.

To achieve the above object, according to an example of the present disclosure, a driving assistance apparatus for a vehicle is provided to include a determination section and an activation section. The determination section determines whether a drowsy-tending state takes place. The drowsy-tending state is a state where a driver of the vehicle tends to be drowsy. The activation section activates a drowsy driving preventing function when it is determined that drowsy-tending state takes place. The drowsy driving prevention function is to detect a drowsiness of the driver and awake the driver being drowsy.

Under such a configuration, even in cases that the drowsy driving preventing function provided in a host vehicle is stopped intentionally, the drowsy driving preventing function may be activated compulsorily when the driver becomes the state of tending to be sleepy. The drowsy driving may be thus inhibited more certainly.

### BRIEF DESCRIPTION OF THE DRAWINGS

The above and other objects, features, and advantages of the present disclosure will become more apparent from the following detailed description made with reference to the accompanying drawings. In the drawings:

FIGS. 1A, 1B are block diagrams illustrating a driving assistance apparatus according to embodiments of the present disclosure;

FIG. 2 is a flowchart diagram illustrating an activation process according to a first embodiment of the present disclosure; and

FIG. 3 is a flowchart diagram illustrating an activation process according to a second embodiment of the present disclosure.

### DETAILED DESCRIPTION

Embodiments of the present disclosure are explained with reference to drawings. In addition, the embodiments of the present disclosure can be modified in various manners within a technical scope of the present disclosure without being limited to the following embodiment.

### Explanation of Configuration

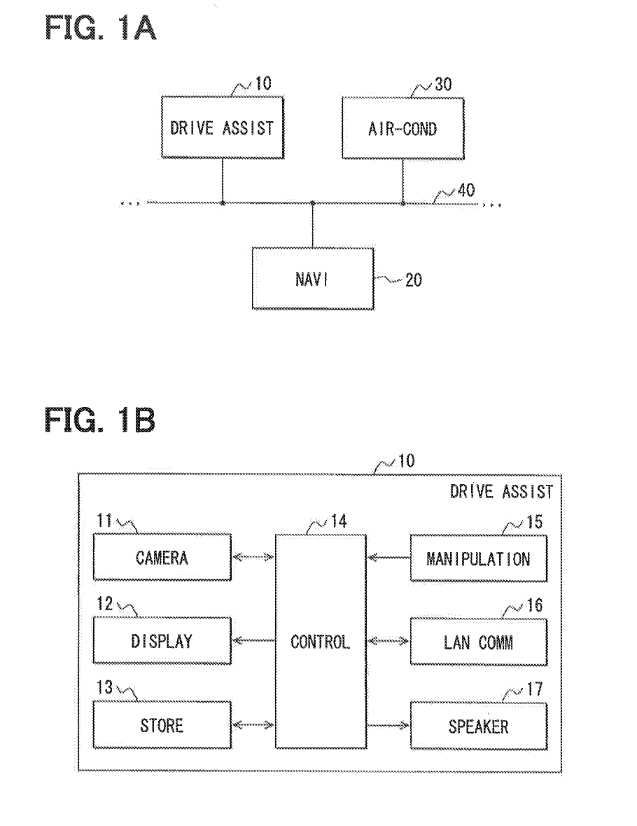

With reference to FIG. 1A, a driving assistance apparatus 10 mounted in a host vehicle according to embodiments of the present disclosure detects drowsiness of a driver of the vehicle and includes a drowsy driving preventing function that outputs a warning sound in order to awake the driver who is drowsy. The driving assistance apparatus 10 is connected to an in-vehicle LAN (Local Area Network) 40, which ECUs (Electronic Control Units) such as a navigation apparatus 20 or air-conditioner 30 are also connected to.

With reference to FIG. 1B, the driving assistance apparatus 10 includes a camera 11 which irradiates a face of the driver who sits on a driver's seat and captures an image of the face of the driver; a display portion 12 that includes an LCD (Liquid Crystal Display) to display a variety of information; a storage portion 13 that includes a nonvolatile memory such as a flash memory; a control circuit 14 that contains a known microcomputer having a CPU, ROM, RAM, I/O, and a bus line connecting the foregoing components or the like to operate according to a program stored in the ROM; a manipulation portion 15 that includes buttons to receive various manipulations of ON/OFF of the drowsy driving preventing function; an in-vehicle LAN communication portion 16 that communicates with other ECUs via the in-vehicle LAN 40; and a speaker 17.

### Explanation of Operation

### First Embodiment

The following will explain an operation of the driving assistance apparatus 10 according to a first embodiment of the present disclosure.

As explained above, the driving assistance apparatus 10 includes a drowsy driving preventing function for awaking the driver who is drowsy. The drowsy driving preventing function detects a level of drowsiness of the driver with a well-known method based on a facial image of the driver whose image is captured by the camera 11.

For example, the facial image of the driver is used to detect the distance between the left corner and the right corner of the mouth; the distance between (i) the center of the inner corner and outer corner of an eye and (ii) the center of the eyebrow; and the inclination of the head frontward or backward. Those measurement results are compared with reference values at the time when the driver is awake. The comparison result may be used to detect the level of the drowsiness of the driver. Alternatively, the level of the drowsiness of the driver may be detected using a well-known technology based on a driving manipulation of a driver and a behavior of a host vehicle.

The driving assistance apparatus 10 outputs a warning sound via the speaker 17 so as to awake the driver when the level of the drowsiness of the driver exceeds a predetermined threshold value. Without need to be limited to the warning sound, for example, the driver may be awoken by making a luminescence apparatus mounted in a vehicle interior emit lights, or making a vibration generator vibrate the seat of the driver. Further, the driver may be awoken by reducing a vehicle-interior temperature through communicating with the air-conditioner 30 via the in-vehicle LAN 40. Further, the driver may be awoken by opening an automatic window (unshown) wide through controlling the automatic window via the in-vehicle LAN 40.

Furthermore, the driving assistance apparatus 10 may transmit an E-mail to report the danger of drowsy driving to contact persons registered previously such as an administrator who manages driving of the driver, and a family of the driver when the drowsiness of the driver exceeds a threshold value. Such reports may use a wireless communications apparatus (unshown) such as DCM (Data Communication Module) connected to the in-vehicle LAN 40, or a cellular phone (unshown) connected to the driving assistance apparatus 10.

The drowsy driving preventing function may detect erroneously a level of the drowsiness of the driver; thereby, the warning sound may be outputted although the driver is awake. Such erroneous detection may occur frequently, possibly resulting in that the driver may deactivate (i.e., turn off) the drowsy driving preventing function into an off state. Therefore, the driving assistance apparatus 10 has a function to activate compulsorily the drowsy driving preventing function into an on state when the driver becomes the state of tending to be drowsy.

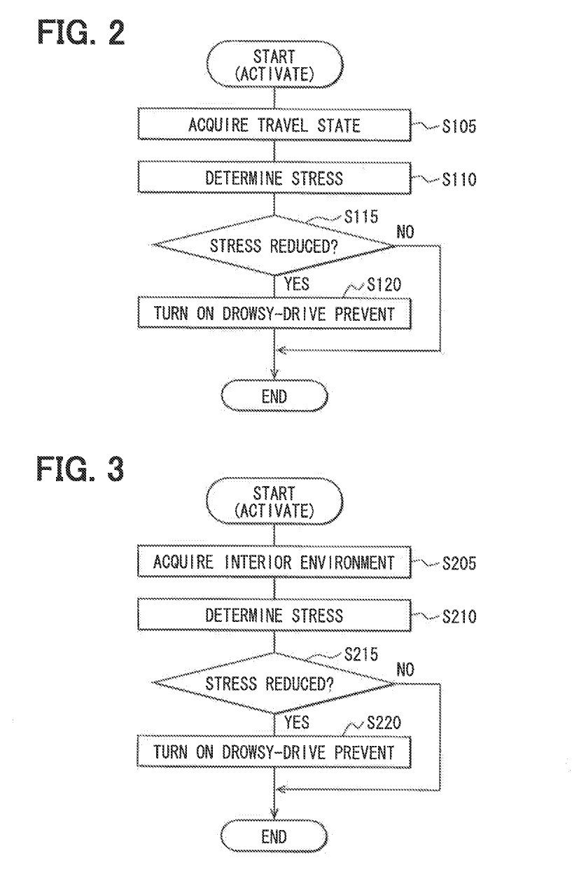

The following will explain an activation process to activate compulsorily the drowsy driving preventing function into an on state with reference to a flowchart in FIG. 2. The present process is repeatedly executed, e.g., a cycle of 0.5 second, during driving of the vehicle. It is further noted that a flowchart in the present application includes sections (also referred to as steps), which are represented, for instance, as S105. Further, each section can be divided into several sections while several sections can be combined into a single section. Furthermore, each of thus configured sections can be referred to as a module, device, or means and achieved not only (i) as a software section in combination with a hardware unit (e.g., computer), but also (ii) as a hardware section, including or not including a function of a related apparatus. Further, the hardware section may be inside of a microcomputer.

At S105, the control circuit 14 of the driving assistance apparatus 10 communicates with ECUs such as the navigation apparatus 20 via the in-vehicle LAN 40 so as to acquire travel state information. The travel state information includes (i) a host-vehicle-peripheral state such as traffic of vicinity of the host vehicle acquired from VICS (Vehicle Information Communication System, registered trademark), a road width and shape of a road under travel, and installation condition of traffic signals of the road; and (ii) a host-vehicle state such as a vehicle speed and steering angle (an angle of the steering wheel).

At S110, the control circuit 14 determines or estimates a degree of stress of the driver due to driving based on the travel state information, thereby storing a determination result or estimation result as history information. For instance, the degree of stress of the driver may be estimated to be high when the driver drives the vehicle in a road that has a narrow road width and many curves, or a road having many traffic signals, or when the driver drives the vehicle at a high speed in a road having a heavy traffic. In contrast, for example, the degree of stress of the driver may be estimated to be low when the driver drives the vehicle in a road that is a straight road with a wide road width, a road having less traffic signals, or a road having less traffic, or when the driver drives the vehicle at a low speed in a road under a congestion state. Thus, the stress of the driver may be estimated comprehensively based on the traffic, the road width, the road shape, the installation of traffic signals, the vehicle velocity, and the steering angle; thus, this permits the degree of stress to be classified into several levels or steps.

At S115, the control circuit 14 determines whether the stress is changed from a high stress status into a low stress status based on the history information of the stress of the driver. When the above determination at S115 is affirmed (YES), the driver is supposed to be in the state of tending to be drowsy. The processing proceeds to S120. When the determination at S115 is negated (NO), the present process ends.

At S120, when the drowsy driving preventing function is in the off state, the control circuit 14 activates the function into an on state compulsorily; then, the present process ends.

### Effect

The driving assistance apparatus 10 according to the first embodiment activates the drowsy driving preventing function into an on state compulsorily when the driver is regarded as being in a state of tending to be drowsy. The state of tending to be drowsy is determined when a high stress status of the driver is changed into a low stress status of the driver. The high stress status is a status where driving with a high stress continues more than a predetermined time period to thereby accumulate a fatigue of the driver. The low stress status is a status where the stress of driving decreases, i.e., the tension of the driver is apt to decrease. Thus, the drowsy driving preventing function may be activated suitably when the driver has possibly a high danger to tend to be drowsy. The drowsy driving may be thus inhibited more certainly.

### Second Embodiment

The following will explain an operation of the driving assistance apparatus 10 according to a second embodiment of the present disclosure. The driving assistance apparatus 10 according to the second embodiment also has the same drowsy driving preventing function as that of the first embodiment, but differs from the first embodiment in the following. That is, the drowsy driving preventing function is activated compulsorily into an on state based on the history of the travel state of the host vehicle in the first embodiment; in contrast, the drowsy driving preventing function is activated compulsorily into an on state based on a vehicle-interior environment of the host vehicle such as a vehicle-interior temperature or humidity.

The following will explain an activation process to activate compulsorily the drowsy driving preventing function into an on state based on the vehicle-interior environment with reference to a flowchart in FIG. 3. The present process is repeatedly executed, e.g., a cycle of 0.5 second, during driving of the vehicle.

At S205, the control circuit 14 of the driving assistance apparatus 10 communicates with ECUs such as the air-conditioner 30 via the in-vehicle LAN 40, and acquires the vehicle-interior environment information which indicates the vehicle-interior environments such as (i) vehicle-interior temperature and humidity, and (ii) an air quantity sent out from the air-conditioner 30. The processing then proceeds to S210.

At S210, the control circuit 14 determines or estimates the degree of stress of the driver due to vehicle-interior environments (i.e., the degree of discomfort in the vehicle interior) based on the vehicle-interior environment information, then storing a determination result or an estimation result as history information.

For example, when the vehicle-interior temperature and humidity, and the air quantity from the air-conditioner 30 are within a predetermined range, the driver may be comfortable in the driving and estimated to be in a low stress status. In contrast, as the vehicle-interior temperature or humidity, or the air quantity from the air-conditioner 30 deviates from within the predetermined range to increase from an upper limit or decrease from a lower limit, the driver may be more uncomfortable in the driving and estimated to be in a high stress status. Thus, the stress of the driver may be estimated comprehensively based on the vehicle-interior temperature or humidity, or the air quantity from the air-conditioner 30. This permits the degree of the stress to be classified into several levels or steps.

At S215, the control circuit 14 determines whether the stress is changed from the high stress status into the low stress status based on history information of the stress of the driver due to vehicle-interior environments. When the above determination at S215 is affirmed (YES), the driver is supposed to be in the state of trending to be drowsy. The processing proceeds to S220. When the determination at S215 is negated (NO), the present process ends.

At S220, when the drowsy driving preventing function is in an off state, the control circuit 14 activates the function into an on state compulsorily. The present process then ends.

### Effect

The driving assistance apparatus 10 according to the second embodiment activates the drowsy driving preventing function into an on state compulsorily when the driver is estimated to be in a state of tending to be drowsy in cases that the vehicle-interior environment changes from a discomfort status into a comfort status. Thus, the drowsy driving preventing function is activated suitably when the driver has possibly a high danger to tend to be drowsy. The drowsy driving may be thus inhibited more certainly.

### Other Embodiments

(1) In the first embodiment and the second embodiment, the driving assistance apparatus 10 determines the state of tending to be drowsy when the stress of the driver due to driving or vehicle-interior environments changes from the high stress status to the low stress status with reference to the history information. Without need to be limited thereto, the state of tending to be drowsy may be determined when the low stress status due to driving or vehicle-interior environments continues more than a predetermined period. Even such a configuration can provide a similar effect.

(2) Further, the state of tending to be drowsy may be determined when it is determined that the driving continues more than a predetermined period as a result measurement of a duration of the driving. Yet further, the state of tending to be drowsy may be determined when the time zone for driving is specified and the specified driving is performed from midnight to dawn, for instance. Even such a configuration can provide a similar effect.

(3) In addition, the above embodiments have a configuration where the driving assistance apparatus 10 having a drowsy driving preventing function determines whether a driver is in the state of tending to be drowsy. There is no need to be limited thereto. For example, an ECU such as the navigation apparatus 20 may determine whether a state where a driver of the vehicle tends to be drowsy takes place using a technology similar to that of the above embodiments. When determining affirmatively, an instruction may be issued to the driving assistance apparatus 10 to activate the drowsy driving preventing function into an on state via the in-vehicle LAN 40. Even such a configuration can provide a similar effect.

The control circuit 14 may function as a determination section by executing S115 of the activation process in the first embodiment or S215 of the activation process in the second embodiment. The determination section may be also referred to as a drowsy-tending state determination section. Further, the control circuit 14 may function as an activation section by executing S120 of the activation process in the first embodiment or S220 of the activation process in the second embodiment. Further, the control circuit 14 may function as a travel state detection section by executing S105 of the activation process in the first embodiment; the control circuit 14 may function as a vehicle-interior environment detection section by executing S205 of the activation process in the second embodiment.

Yet further, the control circuit 14 may function as a stress determination section by executing S110 of the activation process in the first embodiment or S210 of the activation process in the second embodiment. The stress determination section may be also referred to as a stress estimation section. In addition, the stress determination section may be incorporated into the above drowsy-tending state determination section.

Aspects of the disclosure described herein are set out in the following clauses.

According to a first aspect, a driving assistance apparatus for a vehicle is provided to include a determination section and an activation section. The determination section determines whether a drowsy-tending state takes place. The drowsy-tending state is a state where a driver of the vehicle tends to be drowsy. The activation section activates a drowsy driving preventing function when it is determined that drowsy-tending state takes place. The drowsy driving prevention function is to detect a drowsiness of the driver and awake the driver being drowsy.

According to a second aspect being optional, in cases that the drowsy driving preventing function is deactivated compulsorily, the activation section may re-activate the drowsy driving preventing function when the determination section determines that the drowsy-tending state takes place.

Such a configuration may inhibit the drowsy driving more certainly even when the drowsy driving preventing function provided in a host vehicle is compulsorily stopped by a manipulation of a driver. The continuity of monotonous driving such as driving a long straight road may reduce a stress due to driving. Long-time and low-speed driving may be caused forcibly by traffic congestion. Such cases may reduce a feeling of tension of the driver, causing the driver to tend to be drowsy.

To that end, according to a third aspect being optional, a travel state detection section may be further included to detect a travel state of the vehicle. The determination section may determine whether the drowsy-tending state takes place based on the travel state detected by the travel state detection section.

The continuous monotonous driving or the involvement in traffic congestion may provide a travel state which reduces the feeling of tension of the driver. In such cases, under the above configuration, the driver is regarded as being in a state of tending to be drowsy and the drowsy driving preventing function is thereby activated. The drowsy driving may be thus inhibited more certainly. However, the continuous monotonous driving may not always induce the drowsiness to the driver. Further, the drowsy driving preventing function may cause an erroneous detection of drowsiness of the driver. When the drowsy driving preventing function is always activated in the monotonous driving, the process for awaking the driver may be performed repeatedly more than needed, possibly providing a sense of discomfort to the driver.

In contrast, traveling a road having curves continuously may provide a high stress, causing the driver to tend to drive with a feeling of tension. Such a travel state continuing may accumulate fatigue of the driver. Under the accumulated fatigue of the driver, the travel state of tending to reduce the feeling of tension may take place. Such a case may provide the driver with much higher danger of tending to be drowsy.

To that end, according to a fourth aspect being optional, the determination section may determine whether a change arises in a stress of the driver due to driving of the vehicle based on a history of the travel state detected by the travel state detection section. The determination section may determine that the drowsy-tending state takes place when determining that the change arises such that the stress due to driving is reduced.

Under the condition that the travel state providing a high stress due to driving continues to accumulate the fatigue of the driver, the travel state may be changed into the state of reducing the stress due to driving or the feeling of tension of the driver. Such a change of the travel state may be regarded as a state of causing the driver to tend to be drowsy. Thus, the drowsy driving preventing function is activated only when the driver has possibly a high danger to tend to be drowsy. Even when an erroneous detection by the drowsy driving preventing function is apt to occur, a sense of discomfort may be inhibited from being provided to the driver. The drowsy driving may be thus inhibited more certainly.

Further, for instance, when the vehicle interior or compartment is maintained at a comfortable temperature and humidity, the driver may tend to be drowsy more.

To that end, according to a fifth aspect being optional, a vehicle-interior environment detection section may be further included to detect an environment in an interior of the vehicle. The determination section may determine whether the drowsy-tending state takes place based on the environment detected by the vehicle-interior environment detection section.

Such a configuration regards the comfortable vehicle-interior environment as a state causing the driver to tend to be drowsy, thereby activating the drowsy driving preventing function. The drowsy driving may be thus inhibited more certainly.

However, even with the comfortable vehicle-interior environment, the driver may not always tend to be drowsy. Further, the drowsy driving preventing function may cause an erroneous detection of drowsiness of the driver. When the drowsy driving preventing function is always activated under the comfortable vehicle-interior environment, the process for awaking the driver may be performed repeatedly more than needed, possibly providing a sense of discomfort to the driver.

In contrast, under the uncomfortable vehicle-interior environment for the driver such as high temperature and high humidity, the driver may not tend to be drowsy. Thus, when the vehicle-interior environment changes from a discomfort status into a comfort status, the driver may be provided with much higher danger of tending to be drowsy.

To that end, according to a sixth aspect being optional, the determination section may determine whether a change in the environment of the interior of the vehicle arises based on a history of the environment detected by the vehicle-interior environment detection section. The change is from a discomfort status of the driver into a comfort status of the driver. The determination section may determine that the drowsy-tending state takes place when determining that the change from the discomfort status into the comfort status arises in the environment of the interior,

Such a configuration regards the change of the vehicle-interior environment from the discomfort status into the comfort status as the state causing the driver to tend to be drowsy. Thus, the drowsy driving preventing function is activated only when the driver has possibly a high danger to tend to be drowsy. Even when an erroneous detection by the drowsy driving preventing function is apt to occur, a sense of discomfort may be inhibited from being provided to the driver. The drowsy driving may be thus inhibited more certainly.

While the present disclosure has been described with reference to preferred embodiments thereof, it is to be understood that the disclosure is not limited to the preferred embodiments and constructions. The present disclosure is intended to cover various modification and equivalent arrangements. In addition, while the various combinations and configurations, which are preferred, other combinations and configurations, including more, less or only a single element, are also within the spirit and scope of the present disclosure.

What is claimed is:

1. A driving assistance apparatus for a vehicle, the apparatus comprising:
a determination section that determines whether a drowsy-tending state takes place, the drowsy-tending state being a state where a driver of the vehicle tends to be drowsy; and
an activation section that activates a drowsy driving preventing function when it is determined that drowsy-tending state takes place, the drowsy driving prevention function detecting a drowsiness of the driver and awaking the driver being drowsy.

2. The driving assistance apparatus according to claim 1, wherein:
in cases that the drowsy driving preventing function is deactivated compulsorily, the activation section re-activates the drowsy driving preventing function when the determination section determines that the drowsy-tending state takes place.

3. The driving assistance apparatus according to claim 1, further comprising:
a travel state detection section that detects a travel state of the vehicle, wherein:
the determination section determines whether the drowsy-tending state takes place based on the travel state detected by the travel state detection section.

4. The driving assistance apparatus according to claim 3, wherein:
the determination section determines whether a change arises in a stress of the driver due to driving of the vehicle based on a history of the travel state detected by the travel state detection section; and
the determination section determines that the drowsy-tending state takes place when determining that the change arises such that the stress due to driving is reduced.

5. The driving assistance apparatus according to claim 1, further comprising:
a vehicle-interior environment detection section that detects an environment in an interior of the vehicle, wherein:
the determination section determines whether the drowsy-tending state takes place based on the environment detected by the vehicle-interior environment detection section.

6. The driving assistance apparatus according to claim 5, wherein:
the determination section determines whether a change in the environment of the interior of the vehicle arises, the change being from a discomfort status of the driver into a comfort status of the driver, based on a history of the environment detected by the vehicle-interior environment detection section; and
the determination section determines that the drowsy-tending state takes place when determining that the change from the discomfort status into the comfort status arises in the environment of the interior.
